(19) United States
(12) Patent Application Publication
(10) Pub. No.: US 2004/0030588 A1
(43) Pub. Date: Feb. 12, 2004

(54) Method of timing notification letters from lender

(75) Inventors: Michael R. McMillian, Alexandria, VA (US); Douglas L. Falvey, Covington, KY (US); Deborah Mardis, Edgewood, KY (US); Marc P. Tepe, Ft. Thomas, KY (US); Donald L. Marthey, Milford, OH (US)

Correspondence Address: WOOD, HERRON & EVANS, LLP, 2700 CAREW TOWER, 441 VINE STREET, CINCINNATI, OH, 45202, US

(73) Assignee: American Modern Insurance Group, Inc.

(21) Appl. No.: 10/215,643

(22) Filed: Aug. 9, 2002

(51) Int. Cl. G06F 17/60

(52) U.S. Cl. 705/4

(57) ABSTRACT

The time that a notification letter is sent from a lender to an insured upon expiration of an insurance binder, expiration of an insurance policy or cancellation of an insurance policy is ascertained by empirically determining typical delay factors based on particular insurance companies. These can include typical mailing delay factors and the typical response time of the individual insured. These are combined and compared with minimum allowed delay factors and maximum allowable delay factor set by the lender. The empirically determined delay factor is used to determine the time a notice is sent out if it falls between the minimum delay factor and the maximum delay factor. This prevents unnecessary notification letters being sent to borrowers.

In order to obtain a loan, banks or other lending institutions generally require collateral from the borrower. When collateral is provided, the lender also will require that the collateral be insured to prevent loss of the collateral in the event of a casualty event. If for any reason the insured/borrower fails to make payments on his insurance or fails to renew his insurance, the insurer will typically be required to send notification to the lender who in turn will take certain steps. Generally the first step is to notify the borrower that the insurance has lapsed and to require the borrower to reinstate the insurance and notify the borrower that failure to take these steps will have certain consequences.

The lender prefers not to send any such letter unless it is necessary. Therefore the lender may delay sending such a notification to the borrower to take into account delays in the mail and like. Frequently borrowers take a certain amount of time to make payments to the insurance company. The insurance company itself may delay sending out policy binders, policies, renewals and reinstatement notices.

These can delay notification to the lender causing them to send out a notification to the borrower when it is unnecessary.

### SUMMARY OF THE INVENTION

The present invention is premised on the realization that inadvertent unnecessary notifications can be reduced and/or eliminated by monitoring the timing of certain events associated with insuring collateral.

More particularly the present invention is premised on the realization that by monitoring various delay factors including mail delivery delay factors, binder time delay factors, cancellation time delay factors, renewal time delay factors and in particular monitoring these with respect to the individual insurers and borrowers, one can more accurately determine if insurance has lapsed. Thus, upon a triggering event such as the receipt of an insurance cancellation notice by a lender or his representative, the various delay factors will be added together to determine when a notice should be sent to the borrower. If this delay factor is less than the usual delay used by the lender or greater than the maximum time the lender is willing to wait, it can be overridden. Otherwise, the delay factor will determine when the borrower should be notified. This will in turn prevent the unnecessary notification to the borrower and reduce administrative expenses on behalf of the lender.

The present invention will be further appreciated in light of the following detailed description:

### DETAILED DESCRIPTION

The present invention is a method of determining a delay factor to be used by a lender or his representative in sending out insurance lapse notification letters, including cancellation notifications to a borrower. Tracking of insurance is frequently conducted by third party representatives of the lender and thus in the present invention the term lender is intended to encompass the lender's representatives as well. In the present invention, lender is intended to include a variety of different lending institutions such as banks, savings and loans, private lending institutions and the like.

Typically the methodology of the present invention will be utilized upon a triggering event. A triggering event can be a variety of different events. Typically it will be an expiration date of an insurance binder or policy or a cancellation date which may be set up by a cancellation notice from the insurance company. Typically the insurance company is required to send notice of such cancellation to the lender as well as the borrower.

The present invention further requires that one track actual historical delays. This will be accomplished by monitoring the time it takes for various events to occur and categorizing these based on the particular insurance company and the insured. One can pick and choose appropriate delay factors as one prefers. Many of these delay factors are discussed below. If any of these delay factors are not determined or are undeterminable, they can either be ignored or a delay factor can be assumed based on prior experience.

The present invention preferably relies on analysis of up to four or more separate time delay factors to determine if insurance on collateral has improperly lapsed and to determine if it is appropriate for the lender to notify the borrower of the insurance lapse.

Preferably the time delay factors will be based on the historical actions of the policyholder. If these are unavailable, alternate factors can be derived from the insurance company. These insurance company factors will simply be an average of all policyholders and therefore a secondary source of information if the policyholder information is unavailable. These are divided into several factors.

The first factor is a mail delivery delay factor D₁. The number of days that pass between the date a piece of mail is printed and the date it is received by the lender will vary substantially from one piece of mail to another. This varies by location of the service center printing the insurance document and the type of collateral/policy, i.e., automobile, home owner, marine, motorcycle, etc. Thus, the time between printing a piece of mail and receipt of the mail by the lender must be recorded and categorized according to any variety of such factors including the originator of the correspondence, the type of collateral, the type of policy (hazard, flood, automobile), etc. A record is maintained of this so that for each particular insurance company and each particular service center an average mail delivery factor D₁ is established for each type of collateral and policy.

If the triggering event is policy expiration, the second delay factor D_{2I} is the binder time delay factor. This is the number of days that pass between the date a binder is issued and the date the policy is issued. This varies substantially from account to account. The amount of time that lapses between the issue date of the binder and the policy varies by insurance carrier and type of collateral/policy. Further, the time between the issuance of a binder and a policy to issue for a new loan may differ from the time delay when a binder and policy issue when a borrower simply changes insurance carriers. Thus, a binder time delay factor is empirically determined for each insurance carrier, potentially for each type of collateral/policy and optionally for new loans and changes in insurance carriers.

If the triggering event is a policy cancellation date, the second delay factor D_{2Ii} is the cancellation time delay factor. Because many insurance companies accept a premium payment after a policy is actually cancelled and automatically reinstates the policy, this can actually encourage the insured to delay payment. Once an insured becomes aware of this defacto grace period, they develop a payment pattern that takes advantage of the grace period. The cancellation time delay factor is calculated by determining the number of days that pass between the effective date of the cancellation and the date the reinstatement is issued. Separate delay factors can be determined for interim cancellations and cancellation at time of renewal. Again, this is done on a company by company basis.

If the insurance policy renewal date is the triggering event, the second time delay factor D_{2III} is the renewal time factor. This is based on renewal notification strategy used by insurance companies and insurance agents. Some insurance companies send a billing notice and wait for the insured to make a renewal payment before preparing a renewal declaration. Some insurance companies or agencies due to workload and/or processing limitations, send the lender copy of a renewal notice after the prior policy has expired. Thus, the renewal time factor D_{2iiI} is calculated by determining the number of days between the effective date of the renewal and the date the declaration was prepared. The renewal time factor will report the average number of days the declaration was prepared before or after the policy effective renewal date. This renewal time factor is established for each policy of a borrower for each collateral insured by the insurance company. Separate statistics for mortgages with and without an escrow for the insurance payment should be established.

Finally, the lender may establish its own minimum and maximum delay factors. For example, the lender may typically send out notice letters ten days after the expiration date of a binder. This would be the minimum delay. They may establish for purposes of this methodology a maximum delay that they are willing to tolerate regardless of the typical delay factors. For example, a maximum delay after an expiration of a binder may be set by the lender at 45-days. This is a policy determination of the lender.

Thus, the invention functions as follows: Initially the lender will establish the delay minimum Dₘᵢₙ and a delay maximum Dₘₐₓ. Further, they will empirically determine a plurality of delay factors D₁-D_{y} for each policyholder and for each insurance company. Upon a triggering event, they will then combine the relevant D₁, D₂-D_{y} to establish a Dₜₒₜₐₗ. Preferably the data will be derived empirically from past actions of the individual policyholder. If there is no acceptable data from the policyholder, the delay factors D₁, D₂-D_{z} for the insurer will be combined to obtain Dₜₒₜₐₗ. Dₜₒₜₐₗ will then be compared with the Dₘₐₓ and Dₘᵢₙ. If the Dₜₒₜₐₗ is greater than Dₘₐₓ, a notice will be sent at the Dₘₐₓ date. If the Dₜₒₜₐₗ is less than the Dₘᵢₙ, then Dₘᵢₙ will be used. However where Dₜₒₜₐₗ is greater than Dₘᵢₙ and less than Dₘₐₓ, Dₜₒₜₐₗ will be used. The notice from the lender or its representative will be sent Dₜₒₜₐₗ days after the triggering event. This is further explained by the following hypothetical examples.

### Hypothetical Examples

The tracking system of the present invention will calculate the different scheduling delay factors as the insurance mail is processed. It will use the statistics regarding the current mail to update the individual policyholder's average delay factors and, at the collateral level, the insurance company's average delay factors. The tracking program will use these scheduling delay factors to determine if the timing of a letter needs to be delayed. The following are some examples of how this will work. Positive numbers indicate an action is accomplished in advance of a due date.

Lender Notice Printing Cycle

| | Normal Dₘᵢₙ | Use Delay | Dₘₐₓ |
|---|---|---|---|
| Letter Type | Printing Schedule | Factor Max | Delay |
| Binder Expiration | 10 days after | Yes | 45 days |
| Letter | Binder Exp. Date | | |
| Cancellation | 10 days after | Yes | 30 days |
| Letter | Cancellation Date | | |
| Missing Renewal | On policy Expiration | Yes | 21 days |
| | Date | | |

Primary Delay Factors

| | Dᵢ | D₂ᵢ | D₂ᵢᵢ | D₂ᵢᵢᵢ |
|---|---|---|---|---|
| | Mail Delivery | Binder | Cancellation | Renewal |
| | Time Delay | Time Delay | Time Delay | Time Delay |
| Policyholder | Factor | Factor | Factor | Factor |
| 111 | −9 days | Unknown | Unknown | Unknown |
| 222 | −4 days | −70 days | −7 days | +15 days |
| 333 | −4 days | −25 days | −45 days | −26 days |

Secondary Delay Factors

| | D₁ | D₂ᵢ | D₂ᵢᵢ | D₂ᵢᵢᵢ |
|---|---|---|---|---|
| | Mail Delivery | Binder | Cancellation | Renewal |
| Insurance | Time Delay | Time Delay | Time Delay | Time Delay |
| Company | Factor | Factor | Factor | Factor |
| AAA | −7 days | −35 days | −10 days | −17 days |
| BBB | −4 days | −60 days | −4 days | +15 days |
| CCC | −5 days | −18 days | −39 days | −31 days |

### EXAMPLE 1

Lender receives for policyholder 111 a 30-day binder effective Feb. 1, 2001 on Feb. 25, 2001 from Insurance Company AAA.

Lender X normal binder expiration letter would be scheduled to be printed 10 days after the binder expires. A review of Insurance Company's statistics shows that the policy is normally issued 35 days after the binder expires and there are no policyholder statistics. The Mail Delivery Delay Time of “9” will be added to The Insurance Company's delay factor of “35” and will be used unless it exceeds the maximum delay factor of “45”. Example “1” would have 44 days added to the binder expiration date of Mar. 1, 2001 and would schedule the binder expiration letter on Apr. 5, 2001.

### EXAMPLE 2

Lender receives for policyholder 222 a cancellation effective Mar. 1, 2001 on Feb. 25, 2001 from Insurance Company BBB.

Lender X normal cancellation letter would be scheduled to be printed 10 days after the cancellation date. A review of policyholder's statistics shows that a reinstatement is normally issued 4 days after the cancellation is effective. The Mail Delivery Delay Time of “4” will be added to the policyholder's delay factor of “4” and will be used unless it exceeds the maximum delay factor of “30”. Example “2” would have the cancellation letter sent 10 days after the date the policy cancelled on Mar. 11, 2001 because the policyholder's statistics (4 days) and mail delay factor (4 days) was less than the normal timing of 10 days after the policy cancelled.

### EXAMPLE 3

Lender receives for policyholder 333 a policy effective Mar. 1, 2000 on Mar. 27, 2000 from Insurance Company CCC.

Lender X normal No Renew (Expiration) Letter would be scheduled to be printed on the date a policy expires. A review of policyholder's statistics shows that renewals have been issued 26 days after the policy expires. The Mail Delivery Delay Time of “4” will be added to the policyholder's delay factor of “26” and will be used unless it exceeds the maximum delay factor of “21”. Example “3” would have the non-renewal letter sent on Mar. 22, 2001 because the policyholder's statistics exceed the maximum delay of 21 days as defined by Lender X.

The Renewal Time Delay Factor and Mail Delivery Time Delay Factor are used to determine when an outbound escrow or UNI call would be scheduled.

### EXAMPLE 4

Outbound Escrow Call

Policyholder 222 renewal is received from insurance company BBB on Mar. 15, 2001 effective Mar. 30, 2001. The policyholder information shows that the renewal is issued 15 days prior to the policy's date of expiration. The average mail delivery time for insurance company BBB is 4 days. Using these two timing factors the Outbound Escrow Call would be scheduled for Mar. 19, 2002, 11 days prior to the current policy's expiration date.

With each of these factors one can pick and choose the particular variables used to establish the average time factor. Certainly each of the time factors will vary based on the particular insurance company. Some insurance companies may or may not vary significantly based on collateral and/or policy type. Further, it may be determined that it is not cost effective to monitor certain criteria in determining various time factors. Thus, one can pick and choose the times to monitor in order to establish the actual number for each of the four different time factors.

This has been a description of the present invention along with the preferred method of practicing the present invention, however, the invention itself should only be defined by the appended claims wherein we claim:

1. A method of determining a time delay factor and sending a notice from a lender to a borrower concerning lack of insurance coverage upon a triggering event comprising;
monitoring a plurality of policyholder delay factors and establishing known and unknown policyholder delay factors;
monitoring a plurality of secondary delay factors to determine a plurality of delay factors from past experience with an insurer;
combining known policyholder delay factors upon a triggering event and adding secondary delay factors in place of any unknown policyholder delay factors to obtain a combined delay factor;
comparing said combined delay factor with a pre-established delay maximum and sending said notice to said insured at the lesser of the combined delay factors and the pre-set delay maximum:

2. The method claimed in claim 1 further comprising determining a policyholder delay factor based on mailing time from an insurance company to a particular lender.

3. The method claimed in claim 1 further comprising empirically determining a policyholder delay factor based on mail delivery times from a particular insured to a particular insurance company.

4. The method claimed in claim 1 further comprising establishing a minimum delay wherein said notice is not sent until after said minimum delay.

5. The method claimed in claim 1 wherein said triggering event is expiration of a binder.

6. The method claimed in claim 1 wherein said triggering event is a cancellation date of insurance policy.

7. The method claimed in claim 1 wherein said triggering event is the expiration date of a policy.

8 The method claimed in claim 7 wherein said secondary delay factor is empirically determined based on the average time a particular insurance company sends out a renewal notice.

9. The method claimed in claim 7 wherein said secondary delay factor is based on the average time a particular insurance company sends out a reinstatement notice subsequent to a cancellation.

10. The method claimed in claim 6 wherein the secondary delay factor is based on the average time a particular insurance company sends out a policy subsequent to expiration of a binder.

11. The method claimed in claim 1 further comprising empirically determining a policyholder delay factor based on empirically determined response time of a particular insured to a particular triggering event.
